(19) United States
(12) Patent Application Publication
(10) Pub. No.: US 2016/0189724 A1
(43) Pub. Date: Jun. 30, 2016

(54) The method of codec selection in the audio transmission process in ICT systems

(71) Applicant: Dominika BANACH-BARAN, Wroclaw (PL)

(72) Inventor: Dominika BANACH-BARAN, Wroclaw (PL)

(73) Assignee: Q4 EUROPE SP. Z O. O., Leszno (PL)

(21) Appl. No.: 14/654,544

(22) PCT Filed: Dec. 30, 2014
(86) PCT No.: PCT/PL2014/000159

§ 371 Date: Jun. 21, 2015

(51) Int. Cl. G10L 19/22; H04L 29/06

(52) U.S. Cl. CPC G10L 19/22; H04L 69/08

(57) ABSTRACT

The object of the invention is a method for selecting a codec which is optimal in terms of the properties of the communication channel in a sound transmission system that uses packet-switched data communications. The method involves continuous measurement of the properties of communication channel in each direction and the selection of a codec optimal for the transmission in a given direction from a set of available codecs.

The object of the invention is a method for selecting audio encoding and decoding algorithms (codecs) in an audio transmission process in ICT systems that utilise packet-switched data communications and in particular in the systems in which the properties of the communication channel vary for each direction of the transmission.

The prior art discloses the arrangement of the connection between the first and second transceiver for the transmission of digital audio in both directions in a form of packets. The instantaneous value of the audio signal as the source of analogue information is converted in an analogue-to-digital converter into a digital value. Then it is encoded and compressed to reduce the codeword length. After receiving the packet, the information on the transmitted audio is sent for decompression and decoding, and then it is sent to the digital-to-analogue converter at the output to obtain analogue signal fed to the loudspeaker in order to generate sound.

The prior art discloses the method of audio transmission in both directions between the first transceiver and the second transceiver in which the first transceiver sends to the second transceiver, via SIP protocol in the data packet, information on the first transceiver, i.e. SIP-URI, IP address. Whereas the list of the encoding and decoding algorithms (codecs) used in the first transceiver is sent via the SDP protocol also included in this packet. The list of the same codecs is included in the second transceiver. After the second transceiver receives a packet, a microcontroller in the second transceiver calculates, on the basis of the measurement of the transmission conditions in the communication channel for the packet from the first transceiver, the values of the parameters representing the properties of the communication channel, such as throughput, transmission delay and the signal fluctuation range, i.e. “jitter”. The microcontroller, on the basis of the parameters in the second transceiver and using an appropriate algorithm, selects the codec adequate to the current properties of the communications channel.

Then, the second transceiver starts sending the packet to the first transceiver. The respective fields of this packet contain the information, in the form of a code for the first transceiver, indicating which codec has been used for audio processing. The first transceiver, after receiving, from the second transceiver the packet in which the information is sent on the codec used, activates the same codec as in the second transceiver. After decoding, the sequence of digital samples of the recorded sound is sent to the digital-to-analogue converter and subsequently to the loudspeaker.

The disadvantage of the conventional method of codec selection is that the selection of a new codec together with the corresponding compression and decompression algorithms needs to be initiated by the first or second transceiver, otherwise the once-selected codec remains selected and will not be changed throughout the entire duration of the connection regardless of the changes in the communication channel properties.

Another disadvantage in the use of the disclosed method for codec selection is the fact that, in order to guarantee proper communication, it is required that the communication channel properties are the same for both directions of transmission. Moreover, using the same codec for the transmission of audio in both directions in case of a communication channel whose transmission properties vary in each direction may lead to interruptions and cause a noticeable deterioration of the quality of the sound reproduced in the first or second transceiver.

The nature of the system according to the invention is that a certain number of audio programmes are entered into the algorithm encoding memory of the microprocessor system of the first and second transceiver, and the same number of decoding programmes are entered into the algorithm decoding memory, and each encoding and decoding programme is assigned a set of values of the communication channel parameters such as throughput, transmission delay and fluctuation, for which a particular encoding and decoding programme is optimal, and a first working register area with address space equal to 100 and a second working register area with address space equal to 3 are reserved in the data memory of the microprocessor system in the first and second transceiver, whereas the second working register area is organised in such a manner that the saved value of a new number replaces the oldest entry, and when the microcomputer system in the second transceiver receives a packet from the first transceiver, the packet and the programme are used to calculate the values of the current communication channel parameters, and the values of these parameters are transmitted to the microprocessor system, which compares these data with the data from communication channels stored in the encoding algorithm memory and this comparison allows the system to select an encoding programme optimal for the given parameters of the communication channel and to assign an identification number of the optimal codec for the direction of the transmission from the first transceiver to the second transceiver, and subsequently the system saves this number in the first working register area and includes in the packet sent to the first transceiver in the codec number field for the opposite direction, and the first transceiver, after receiving the packet from the second transceiver, reads, from the codec number field for the opposite direction, the number of the codec that will be used for processing audio for the transmission direction from the first transceiver to the second transceiver, and the number of the optimal codec for the transmission direction from the second transceiver to the first transceiver is established similar as for the opposite direction, whereas the identification numbers of codecs optimal for the transmission direction from the second transceiver to the first transceiver are saved into the working register area of the first transceiver, and the process of establishing the number of optimal codec continues throughout the entire transmission of packets between the transceivers until the first working register area is full, after which the microprocessor system analyses the content of this area by determining which identification number is most frequent in the registers of this area, and this number is saved into the second working register area, and when this area is full the microprocessor system analyses the content of this area by selecting an identification number of a codec appears twice in a row within these registers and initiating the procedure of codec change by entering into the packet, in the codec number field of the opposite direction, the new codec number, and if no codec appears twice in a row in the second working register area, the procedure of codec change is not initiated, and the procedure of codec change involves entering the number selected from the second working register area into the packet, in the codec number field of the opposite direction, and sending it, and when the working register of the first area is once again full and the most frequent number is selected, entering it into the working register from the second working register area.

The preferred outcome of the method according to the invention is the ability to select the proper codec separately for each direction of the transmission of the encoded audio for a communication channel whose properties are different in each direction and also vary in time.

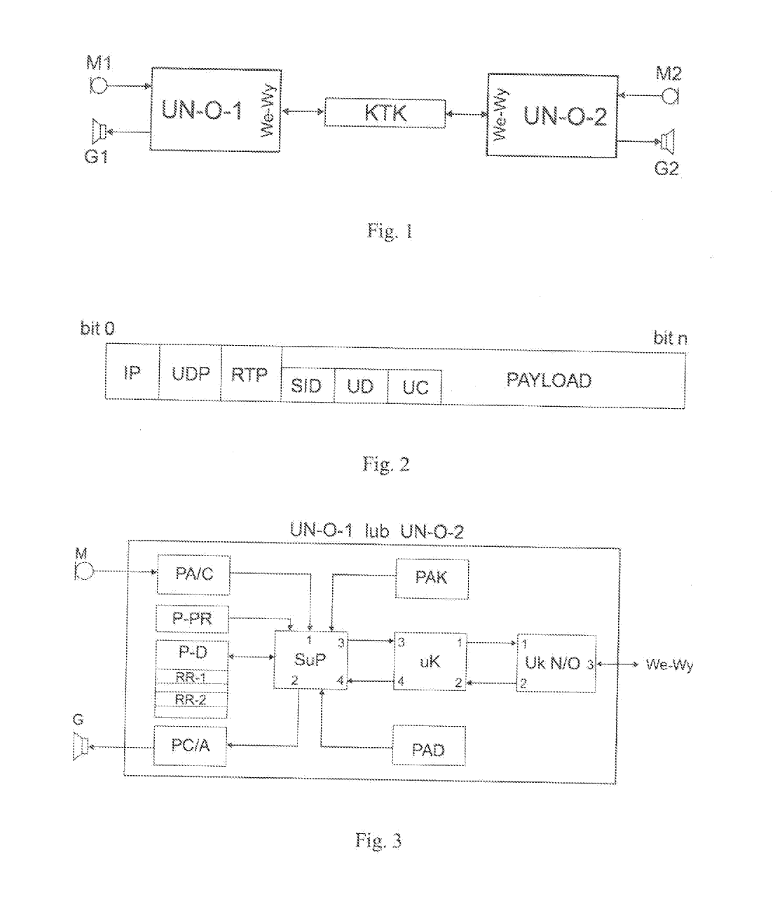

The method according to the invention is used in the system illustrated in the figures, where FIG. 1, which shows the connection between the first and second transceiver, FIG. 2 shows the packet format used in the method to transmit encoded audio between the transceivers, and FIG. 3 is a scheme of the first and second transceiver which use the method according to the invention.

The method is used in a communication system that comprises the first transceiver UN-O-1 and the second transceiver UN-O-2, and the communication between the transceivers is carried out by transmitting packets through a communication channel KTK. One of the transceivers is a master device and the other is a slave device, which is determined at the stage the designing and arranging the system.

The first transceiver UN-O-1 or the second transceiver UN-O-2 has one input signal from microphone M signal, one output for loudspeaker G connection, and one input-output I/O for ITC signal, which is connected to the telecommunication channel KTK. The first transceiver UN-O-1 and the second transceiver UN-O-2 contain an analogue-to-digital converter PA/C, in which the analogue electrical signal from the microphone M is fed to the analogue input for conversion into a digital value proportional to the instantaneous value of the sound level received by the microphone M. The obtained digital value is fed to the first input 1 of the microprocessor system SuP 1, where it is further numerically processed. The first transceiver UN-O-1 and the second transceiver UN-O-2 contain a digital-to-analogue converter PC/A whose input is fed with digital signal from the output of the second 2 microprocessor system SuP, and the output of this converter provides electric analogue signal, which is fed to the loudspeaker G where it is converted to sound.

The microprocessor system SuP in the first transceiver UN-O-1 and also in the second transceiver UN-O-2 is equipped with the connected programme memory P-PR containing a programme that controls the operation of the microprocessor system SuP, data memory P-D, which is used to store the results of the current calculations, encoding algorithm memory PAK, which contains a collection set of programmes that encode the binary values received from the analogue-to-digital converter PA/C, and decoding algorithm memory PAD, which stores programmes that decode the audio signal received from the microcomputer system uK as a sequence of binary digits.

In the data memory P-D of the first transceiver UN-O-1 and the second transceiver UN-O-2 there is a dedicated first working register area RR-1 with the address space of 100. This area is used to store the sequentially entered identification numbers of the audio encoding programmes that were classified as optimal based on the measurement of the properties of the communication channel.

The data memory P-D of the first transceiver UN-O-1 and the second transceiver UN-O-2 there is a dedicated second working register area RR-2 with the address space of 3. This area is used to store the sequentially entered identification number of the audio encoding programme that occurs most frequently in the first working register area RR-1.

The third output 3 of the microprocessor system SuP is connected to the third input 3 of the microcomputer system uK, whose fourth, output 4 is connected to the fourth input 4 of the microprocessor system SuP. The first output 1 of the microcomputer system is connected to the first input 1 the transceiver system Uk N-O, whose third terminal 3 is an input-output I-O line and is connected to the telecommunications channel KTK. The second output 2 of the transceiver system Uk N-O is connected to the second input 2 of the microcomputer system uK.

Each audio encoding programme stored in the encoding algorithm memory PAK has an identification number assigned. Each audio decoding programme is stored in the decoding algorithm memory PAD and has an as identification number assigned. Each encoding programme stored in the encoding algorithm memory PAK has one decoding programme allocated in the decoding algorithm memory PAD, and both programmes have the same number assigned. The encoding programme together with the corresponding decoding programme constitute a codec. Each encoding programme stored in the encoding algorithm memory PAK has assigned, as separate binary numbers, the limit values of the parameters of the communication channel KTK, for which the encoder can be used, and has stored values of parameters such as throughput, transmission delay and the signal fluctuation value, i.e. “jitter”.

The lowest identification number for codecs is assigned to the so-called test codec, which is first used when establishing communication between the first transceiver UN-O-1 and the second transceiver UN-O-2.

The programmes that encode and decode the audio data are entered into the relevant memory of the microprocessor system SuP at the stage of programming the first transceiver UN-O-1 and the second transceiver UN-O-2.

The microprocessor system SuP, after receiving the audio data from the fourth input 4, picks the currently used decoding programme from the decoding algorithm memory PAD, performs the decoding, and then transmits the obtained data to the second output 2, whereas the data is further transmitted to the digital-to-analogue converter PC/A. If the microprocessor system SuP receives audio data from the analogue-to-digital converter PA/C via the first input 1, it picks from the encoding algorithm memory PAK the current encoding programme which is used to encode the data, and the result of the encoding process is transmitted via its third output 3 to the microcomputer system uK for further processing and to be ultimately transmitted to the communication channel KTK. The microcomputer system uK, after receiving the data from the microprocessor system SuP via the third input 3, creates, using a suitable programme, a packet, with a format suitable for the type of communication. The packet contains designated fields, whose number and length depend on the communication standard—for packet-switched data communications the packet contains the following fields: IP containing the number assigned to the network interlace, UDP field containing the user datagram protocol, RTP field containing the real-time transport protocol, PAYLOAD field comprising additional four-bit fields: encoding programme number field UC with the identification number of the encoding programme, decoding programme identification field UD with the identification number of the decoding programme, codec number field for the opposite direction SID with the identification number of the codec which should be currently applied to process audio for the transmission direction opposite than the direction of transmitting the packet.

The transmission of data is initiated by the master transceiver—it may be the first transceiver UN-O-1. The electrical signal from the microphone M is transmitted to the input of the analogue-to-digital converter PA/C, which converts the signal into digital values and feeds it to the first input 1 of the microprocessor system SuP. The programme of the microprocessor system SuP picks the test encoding programme from the encoding algorithm memory PAK and uses it to encode the data received from the analouge-to-digital converter PA/C. The encoded data together with the identification number of the encoder is sent to the microcomputer system uK. In the microcomputer system uK the programme is used to create a packet into which, among others, the identification number of the programme encoding the data contained in this packet is entered in the encoding programme identification field UC. The same number is entered in the codec field for the opposite direction SID. The created packet is sent to the transceiver system Uk N-O, which sends the packet to the telecommunication channel KTK. The data from the telecommunication channel KTK is received by the transceiver system Uk N-O of the second transceiver UN-O-2 and sent to the microcomputer system uK. The properties of the KTK channel are calculated, on the basis of the packet received in the micro-computer system uK of the second transceiver UN-O-2, in the direction from the first transceiver UN-O-1 to the second transceiver UN-O-2. The calculated values are: throughput, transmission delay and jitter. Then the data from the microcomputer uK which contains the encoded audio together with the identification number of the used codec, stored in the packet in encoding programme identification number field UC, are transmitted to the microprocessor system SuP.

The microprocessor system SuP of the second transceiver UN-O-2 compares the calculated values of the parameters of the telecommunication channel KTK with the values stored in the encoding algorithm memory is PAK. This process allows to calculate the identification number of the optimal codec for the current properties of the telecommunication channel KTK in the direction from the first transceiver UN-O-1 to the second transceiver UN-O-2. The obtained identification number of the codec in the second transceiver UN-O-2 is saved in the data memory PD in the first working register area RR-1. Then the microprocessor system SuP reads from the packet the value of the encoding programme number field UC, i.e. the identification number of the programme that was used to encode the audio in the first transceiver UN-O-1 and, from the decoding algorithm memory PAD of the second transceiver UN-O-it picks the decoding programme with the identification number corresponding to the number included in the encoding programme identification field UC, decodes the audio and sends the received data to the second output 2 of the microprocessor system SuP, through which the data is sent to the digital-to-analogue converter PC/A.

The electrical signal from the microphone M is converted and encoded in the second transceiver UN-O-2 in the same manner and using the same systems as in the first transceiver UN-O-1. If the devices are at the stage of establishing communication, the microprocessor system SuP in the second transceiver UN-O-2 also uses the test codec. The number of the codec used to encode the audio sent to from the second transceiver UN-O-2 to the first transceiver UN-O-1 is saved in the packet sent from the second transceiver UN-O-2 to the first transceiver UN-O-1 in the encoding programme identification field UC. At the stage of establishing communication, the same codec identification number as in the encoding programme identification field UC is saved in the packet sent to the first transceiver UN-O-1 in the codec number field for the opposite direction SID.

The microcomputer system uK in the first transceiver UN-O-1 calculates, after receiving the packet, the parameters of the communication channel KTK for the direction from the second transceiver UN-O-2 to the first transceiver UN-O-1 in the same manner as in the second transceiver UN-O-2 for the direction from the first transceiver UN-O-1 to the second transceiver UN-O-2. The number of the codec optimal for the direction from the second transceiver UN-O-2 to the first transceiver UN-O-1 is determined on the basis of the measured parameters of the telecommunication channel KTK for this direction. The designated number of the codec is stored in the first transceiver UN-O-1 in the data memory PD in the first working register area RR-1. The transmission of packets and the measurement of the parameters of the communication channel are repeated until the first working register area RR-1 in the data memory PD of the microprocessor system SuP in both first transceiver UN-O-1 and the second transceiver UN-O-2 is full.

The set of codecs optimal for the transmission direction from the second transceiver UN-O-2 to the first transceiver UN-O-1 is created in the first working register area RR-1 in the data memory PD in the first transceiver UN-O-1, and the set of codecs optimal for the transmission direction from the first transceiver UN-O-1 to the second transceiver UN-O-2 is created in the first working register area RR-1 in the data memory PD in the second transceiver UN-O-2.

When the first working register area RR-1 in the data memory PD is full, its contents are analysed to select the identification number which occurs most frequently within this set. This identification number is saved in the data memory PD in the second working register area RR-2. After entering three consecutive identification numbers of codecs into the second working register area RR-2, the contents of the registers in this area is analysed according to the principle that if two consecutive identification numbers of codecs are the same, the procedure of changing the codec number to the number of the codec which occurs twice in a row is initiated.

The new codec number selected from the second register area RR-2 is entered into the packet in the codec number field for the opposite direction SID and sent to the first transceiver UN-O-1, where it is received. The microcomputer system uK in the first transceiver UN-O-1 reads, from the codec number field for the opposite direction SID of the received packet, the number of the new codec which is to be used to encode audio in the first transceiver UN-O-1. Then the number of the new codec to be used to encode the audio transmitted from the first transceiver UN-O-1 to the second transceiver UN-O-2 is entered into the packet in the encoding programme number field UC, and the packet is sent to the second transceiver UN-O-2. The same procedure is used to select a new codec for the data transmission direction from the second transceiver UN-O-2 to the first transceiver UN-O-1. After each completion of the first working register area RR-1 and the selection of the identification number of the codec occurring most frequently in it, this number is entered in the register from the second working register area RR-2. After the entry into the second working register area RR-2, its content is once again analysed, wherein if the number of the new codec entered into the second working register area RR-2 is the same as the previous one, the codec is changed to a new one, otherwise the codec is not changed.

1. The method of codec selection in the audio transmission process in the ICT systems between the two transceivers is characterised by the fact that in the first transceiver the electrical signal from the microphone output is fed to the input of an analogue-to-digital converter which converts the signal into digital data, and which is then sent to the input of the microprocessor system, which uses a data encoding programme to encode the digital data, and the encoding programme is assigned a decoding programme wherein both of these programmes constitute a codec, which is assigned an identification number, and all the codecs are saved in the programme memory, and the data obtained from the en-coding process is sent to the input of the microcomputer system, where a packet is created, and this packet comprises, among others, encoder number field, encoded audio data field and codec number for the opposite direction field and this packet is sent, via telecommunication connection channel, to the second transceiver, where it is received from the input by the microcomputer system in which software is used to separate the encoded audio data from the packet, and the encoding programme field is read, and the values of the communication channel parameters, such as throughput, transmission latency delay and fluctuation, are calculated on the basis of a received packet, and then the encoded audio data, the communication channel parameters and the en-coding programme number are sent to the microprocessor system, where, on the basis of the received encoding programme number, a de-coding programme with the same number is picked from programme memory, and the decoding programme decodes the data, and the outcome of the data decoding process consists of the data that is fed to the digital-to-analogue converter at the input of which analogue signal is obtained, which is fed to the loudspeaker, and then the second transceiver starts sending the packet to the first transceiver and this packet includes, in the respective fields and in the form of code for the first transceiver, the information about which codec has been used for audio processing, and the first transceiver, after receiving the packet that stores the information about the used codec from the second transceiver, activates the same codec as in the second transceiver and, after de-coding, sends the sequence of digital samples that constitute the recorded sound to the digital-to-analogue converter and then to the loud-speaker, characterised in that
a certain number of audio programmes are entered into the algorithm encoding memory PAK of the microprocessor system SuP of the first transceiver UN-O-1 and the second transceiver UN-O-2, and the same number of decoding programmes are entered into the algorithm decoding memory PAD, and each encoding and decoding programme is assigned a set of values of the communication channel KTK parameters such as throughput, latency delay and fluctuation, for which a particular encoding and decoding programme is optimal, and a first working register area RR-1 with address space equal to 100 and a second working register area RR-2 with address space equal to 3 are reserved in the data memory PD of the microprocessor system SuP in the first transceiver UN-O-1 and the second transceiver UN-O-2, whereas the second working register area RR-2 is organised in such a manner that the saved value of a new number replaces the oldest entry, and when the micro-computer system uK in the second transceiver UN-O-2 receives a pack-et from the first transceiver UN-O-1, the packet and the programme are used to calculate the values of the current communication channel KTK parameters, and the values of these parameters are transmitted to the microprocessor system SuP, which compares these data with the data from communication channels data stored in the encoding algorithm memory PAK and this comparison allows the system to select an en-coding programme optimal for the given parameters of the communication channel KTK and to assign an identification number of the optimal codec for the direction of the transmission from the first transceiver UN-O-1 to the second transceiver UN-O-2, and subsequently the system saves this number in the first working register area RR-1 and includes it in the packet sent to the first transceiver UN-O-1 in the codec number field for the opposite direction SID, and the first transceiver UN-O-1, after receiving the packet from the second transceiver UN-O-2, reads, from the codec number field for the opposite direction SID, the number of the codec that will be used for processing audio for the transmission direction from the first transceiver UN-O-1 to the second transceiver UN-O-2, and the number of the optimal codec for the transmission direction from the second transceiver UN-O-2 to the first transceiver UN-O-1 is established analogously to the opposite direction, whereas the identification numbers of codecs optimal for the transmission direction from the second transceiver UN-O-2 to the first transceiver UN-O-1 are saved into the working register area RR-1 of the first transceiver UN-O-1, and the process of establishing the number of optimal codec continues throughout the entire transmission of packets between the transceivers until the first working register area RR-1 is full, after which the microprocessor system SuP analyses the content of this area by determining which identification number is most frequent in the registers of this area, and this number is saved into the second working register area RR-2, and when this area is full the microprocessor system SuP analyses the content of this area by selecting an identification number of a codec appears twice in a row within these registers and initiating the procedure of codec change by entering into the packet, in the codec number field of the opposite direction SID, the new codec number, and if no codec appears twice in a row in the second working register area RR-2, the procedure of codec change is not initiated, and the procedure of codec change involves entering the number selected from the second working register area RR-2 into the packet, in the codec number field of the opposite direction SID, and sending it, and when the working register of the first area RR-1 is once again full and the most frequent number is selected, entering it into the working register from the second working register area RR-2.
